(19) United States
(12) Patent Application Publication
(10) Pub. No.: US 2005/0108376 A1
(43) Pub. Date: May 19, 2005

(54) Distributed link management functions

(76) Inventors: Manasi Deval, Beaverton, OR (US); Sanjay Bakshi, Beaverton, OR (US); Christian Maciocco, Tigard, OR (US)

Correspondence Address: Julie L. Reed;MARGER JOHNSON & McCOLLOM, P.C., 1030 S.W. Morrison Street, Portland, OR, 97205, US

(21) Appl. No.: 10/713,605

(22) Filed: Nov. 13, 2003

(51) Int. Cl. G06F 15/173

(52) U.S. Cl. 709/223

(57) ABSTRACT

A system includes a control card that has a control processor to execute a control portion of link management. The system also includes a line card having a line processor to execute an offload portion of link management. A communications port allows the system to access a high-capacity communications link and a backplane allows the control card and the line card to communicate.

### BACKGROUND

High-capacity connections, such as optical fiber, may have bit rates in the 10 gigabits per second (Gbps) range and higher. With data circuits having as low as 64 kilobits per second (Kbps) bandwidth requirement, it is possible for one physical link to have hundreds of data links. In one embodiment a data link is a connection between two interfaces to exchange information. Two physical peer devices may have multiple data links between them, all running on the same physical link. There are multiple circuits in a data link and multiple data links in a physical link. For example, two peers may have multiple Internet Protocol (IP) interfaces, multiple Transfer Control Protocol sessions on an IP interface, etc.

In order to better manage these data links, they are sometimes subjected to ‘traffic engineering’ and aggregated into traffic channels. A traffic channel, as the term is used here, is an aggregation of data links that are managed as a whole set. Link management functions, such as those described in the Internet Engineering Task Force's Internet draft of a proposed standard Link Management Protocol, direct the establishment, aggregation and maintenance of the physical links, the data links and the traffic channels.

Currently, a central processor in the network device handles link management functions. These functions may include KeepAlive or HELLO messages also known as link status messages, link verification messages and synchronization messages. Given the high speeds of the physical links, these messages are sent with relatively high frequencies in order among other things to discover as soon as possible failure in the optical network. For example, a HELLO message transmitted under LMP is generally sent for each data link every 150 milliseconds. This frequency is necessary because 150 milliseconds is a relatively long time in a link have a capacity of 10 Gbps.

As technology advances, it is possible that the physical link may reach a capacity of 40 Gbps, providing more opportunity for more links to exist. Current network devices are overwhelmed handling the control and data traffic for the increase in the number of links. In addition, as the numbers of data links increase, error-handling procedures at the control processor will overwhelm the processor, as such errors are potentially reported for each individual data link of the link, and cause other requests to be denied.

Denial of legitimate requests may also occur during a denial of service attack on the link management functions. Typically, link management functions such as LMP separate the control link from the data links. Current network devices may have a control plane or card and a forwarding plane implemented in line cards. The control plane authenticates packets sent from the forwarding plane to the control plane. A denial of service attack may flood the control plane with bogus or ‘spoofed’ control packets, causing the control processor to attempt to authenticate them. The result is that legitimate requests may be denied, as the control processor is too busy trying to authenticate the bogus control packets.

### BRIEF DESCRIPTION OF THE DRAWINGS

Embodiments of the invention may be best understood by reading the disclosure with reference to the drawings, wherein:

FIG. 1 shows an example of two network devices sharing a communications link.

FIG. 2 shows an embodiment of a network device having a distributed architecture to provide link management.

FIG. 3 shows a flowchart of an embodiment of a method to managing communication links.

FIG. 4 shows a flowchart of an embodiment of a method to initialize a control card to provide link management.

FIG. 5 shows a flowchart of an embodiment of a method to initialize an offload card to provide link management.

### DETAILED DESCRIPTION OF THE EMBODIMENTS

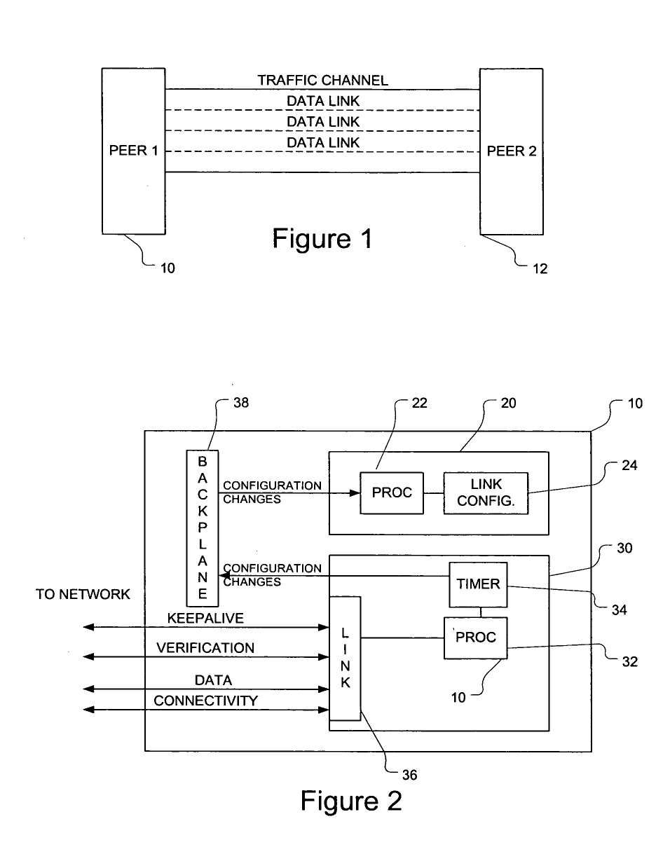

FIG. 1 shows an example of two adjacent peers, 10 and 12, having multiple data links between them. The data links are aggregated into a traffic channel or traffic link. As defined here two adjacent peers are those devices that have a control channel between then. The division of control channels from the data links, such as in LMP, allows for the control channels to be of a different type than the data channels. For example, the data links may be optical fiber, with the control channel being wireless, or Ethernet, etc. For two devices to be referred to as adjacent peers, they must have a control channel between them.

In addition to the separation of the control channels from the data links, the availability of line-cards with processors in the network devices also provides ways to scale link management as the capacity of the physical links increase. A more detailed view of one embodiment of a network device having such a capability is shown in FIG. 2.

The network device 10 has a control card 20, with a general-purpose processor 22 and a store 24 to store the link configuration data. The general-purpose processor may be an Intel® Architecture processor, as an example. The network device also has multiple line cards, such as 30, that may have the ports for the various communication links 36, a processor 32 and at least one timer used in link management 34. The processor may be a network-enabled processor, with a general purpose processor plus at least on reduced instruction set (RISC) microengine. The microengines may be used to maintain the connectivity state machines for various protocols. The line cards and the control card communicate by a backplane 38, which may be a physical backplane like a bus, or a virtual backplane formed from a switching fabric.

In addition to the hardware configuration, a software architecture may allow the control card or plane and the line card or forwarding plane to communicate and coordinate their efforts with respect to various protocols. An example of such an architecture a distributed control plane architecture (DCPA) is that found in copending U.S. patent application Ser. No. 10/______, (attorney docket no. 5038-335), filed simultaneously with the instant application. This is just one example of such a mechanism, but may promote ease of understanding of the invention.

In the DCPA, a DCPA Infrastructure Module (DIM), and a DCPA Communication Library (DCL) allow coordination between portions of a protocol being run on the control card and portions of the protocol being managed by line-cards, referred to here as the offload portion of the protocols. Link management functions may be offloaded to the line cards, including the LMP and its successors and alternatives. Offloading of many of the protocol functions to the line cards preserves the control processor resources, allows the system to scale to higher capacity and therefore, more, links, as well as mitigation of denial of service attacks by spreading out the processing necessary to detect and neutralize those attacks.

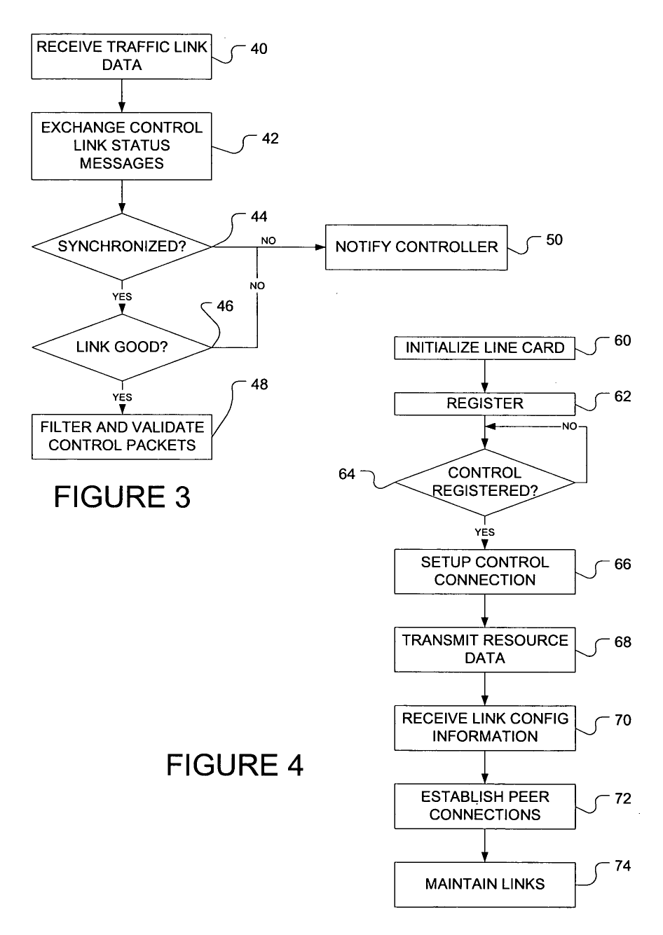

In the embodiment of FIG. 2 that implements the DCPA, the DIM and the DCL would reside on both the control card and the line cards. The coordination between them allows the link management functions to be distributed to the line cards. An embodiment of link management functions in such an architecture is shown in FIG. 3.

In FIG. 3, link management functions are distributed between the control card and multiple line cards. At 40, the line cards receive the traffic link data from the control card. The traffic link data is the information about the mapping of the data links into logical traffic engineering (TE) channels or links. Once the line cards have this information, they can begin to establish control connections between themselves and the adjacent peers at 42. With the establishment of the control and data links, the line cards then begin to maintain and manage the links.

Within the LMP example, the establishment of control connections is performed with an LMP HELLO message typically transmitted every 150 milliseconds for each link. Transmitting multiple HELLO messages across multiple links would normally consume a relatively large amount of the central processor's resources. Offloading this portion of link management to the line-cards would free up those resources. If HELLO messages are not received from a particular link after a predetermined period of time, the offload portion can notify the control portion of the problem. The line cards can continue to maintain and manage links, notifying the control card when problems arise.

At 44, the offload portions of the link management function monitor the synchronization, or matching, of the links. Synchronization means that the interfaces at either end of the link are the same. For example, a link may have interfaces as defined in the Internet Protocol version 4 (IPv4) at each end. This is referred to here a synchronous link. Loss of synchronization may occur with one of the interfaces being changed to IPv6, or becoming unnumbered, where it would not have an IPv4, IPv6 or any other interface. If the offload portion of the link management function detects the loss of synchronization, the line-card notifies the controller portion residing on the control card at 50.

In the LMP, synchronization is a function of the aggregation of the data links into traffic channels. Once the traffic engineering (TE) channels are defined, the data links are to be synchronized. The offload portion is configured with this information and then the line cards can monitor the synchronization.

Optional process 46 may verify that the data links remain valid. If the data links or physical links fail, the controller is notified. In a distributed handling of the link management function, for example, a physical link failure may generate an error message for each data link running on that physical link. Hundreds of link failure messages from each data link would overwhelm the control processor. By offloading the failure monitoring and notification to the line cards, the line card can aggregate, filter and only report the link failure to the control processor once. This allows the control processor to process the link failure by isolating the link failure, although the offload portions may perform the link isolation, the control process can update the configuration information and then directing the line cards to notify the relevant peers of the changes. In the LMP example, the link verification is performed by a ‘BeginVerify’ message that is transmitted and for which acknowledgements are received.

In addition to the link management functions being performed with regard to the synchronization and connectivity, the offload portions may also handle the filtering and validation of control packets at 48. By distributing these functions, it makes it more likely that a denial of service attack will fail, and that the control processor will still be responsive to legitimate requests. Attacking hosts may replay control packets, spoof control packets, alter control packets in transit or transmit malformed control packets. Control packet authentication can be offloaded, relieving the control processor of these tasks. Other candidates for offloading would include encryption and decryption of either control or data packets.

A mechanism that allows this offloading to function is one such as the DCPA mentioned earlier. The mechanism would allow the control card and line cards to discover and communicate with each other about their distributed tasks. An embodiment of a method of preparing a line card for distributed link management is shown in FIG. 4. The line card is initialized at 60. The offloaded portion of the link management registers with the software mechanism that provides transparent communication and control of the distribution at 62. If the control card is not registered at 64, the line cards wait until it is. A control connection is set up between the control card and the line card at 66. The line card transmits data about its resources at 68, such as the physical links it controls or to which it has access, interfaces available on the line card, and processing resources available, as examples. The control card then configures the line card with the link configuration information at 70, including information about data link aggregation into traffic channels.

Once the line cards have the necessary link configuration information, they establish the links between themselves and their adjacent peers at 72. Once the connections are established, the line cards continue to perform the link maintenance functions at 74 mentioned above. A mechanism such as the DCPA provides the ability to discover peers and set up connections with them. The LMP protocol modules communicate with each other using this framework. The communications may include transmission of HELLO messages or other KeepAlive messages, as well as link verification messages and synchronization messages.

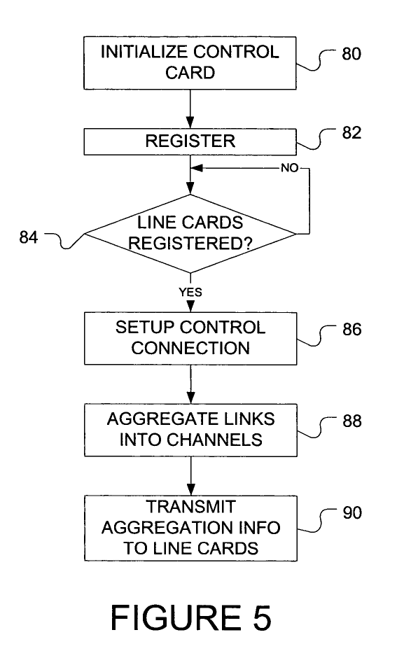

Similarly, a control card can be prepared for distribution of link management functions as is shown in the embodiment of FIG. 5. The control card is initialized at 80 and registers with the same mechanism as the line card at 82. Once the line cards are registered at 84, the control card and line card then discover each other and setup the control connection between them at 86. The control card gathers all of the information about all of the link data and interfaces controlled by the line cards and aggregates them into traffic channels at 88. This information is then used to configure the line cards at 90.

In this manner, then, a mechanism for distributing link management functions is provided. The link management functions being offloaded from the central processor allows for more scalable link management that is more robust to attack.

Thus, although there has been described to this point a particular embodiment for a method and apparatus for distributed link management, it is not intended that such specific references be considered as limitations upon the scope of this invention except in-so-far as set forth in the following claims.

1. A system, comprising:
a control card, comprising:
a control processor to execute a control portion of link management;
a line card, comprising:
a line processor to execute an offload portion of link management;
a communications port to allow the system to access a high-capacity communications link; and
a backplane to allow the control card and the line card to communicate.

2. The network device of claim 1, the control processor further comprising a general-purpose processor.

3. The network device of claim 1, the control processor further comprising an Intel Architecture processor.

4. The network device of claim 1, the line processor further comprising a network-enabled processor.

5. The network device of claim 1, the line processor further comprising an Intel IXP processor.

6. The network device of claim 4, the line processor further comprising at least one reduced instruction set microengine.

7. The network device of claim 1, the backplane further comprising a physical backplane connection.

8. The network device of claim 1, the backplane further comprising a network.

9. A method of managing links in network, comprising:
receiving traffic link data about aggregation of data links into channels from a control card;
exchanging control link status messages with adjacent peers;
monitoring synchronization of data links in a channel;
determining if there has been a control link or data link failure; and
filtering and validating control packets relating to link management.

10. The method of claim 9, comprising identifying link configuration changes and notifying the control card.

11. The method of claim 9, receiving traffic link data further comprising receiving traffic engineered link data in accordance with the Link Management Protocol.

12. The method of claim 9, exchanging control link status further comprising exchanging link status messages.

13. The method of claim 9, monitoring synchronization of data links further comprising:
detecting that a data link has lost synchronization; and
notifying the control card of the loss.

14. The method of claim 9, determining if there has been a control link or data link failure further comprising:
detecting a loss of connectivity in a control channel;
causing an event that notifies the control card; and
setting a status flag indicating that the control channel has failed.

15. The method of claim 9, determining if there has been a control link or data link failure, further comprising:
determining that a local node is not responding to data link verification message; and
notifying the control card of a data link failure.

16. A method of establishing an offload portion of link management, comprising:
initializing a line card;
registering an offload portion of a protocol to be executed by the line-card with a central registration point;
setting up a control connection with a control card;
transmitting resource data to the control card;
receiving configuration information from the control card including information about data links aggregated links into channels;
establishing connections with adjacent peers for each link; and
maintaining the links.

17. The method of claim 16, transmitting resource data further comprising transmitting physical link data, offload-controlled interfaces and processing resources.

18. The method of claim 16, establishing connections further comprising exchanging link status messages.

19. The method of claim 16, establishing connections further comprising exchanging messages to verify data links.

20. The method of claim 16, establishing connections further comprising exchanging synchronization messages.

21. The method of claim 16, maintaining the links further comprising:
monitoring control and data links for failures;
identifying changes in link configurations; and
tracking synchronization in the data links.

22. A method of establishing a control portion of link management, comprising:
initializing a control card;
registering a link management control portion to be executed by the control card with a central registration point;
setting up control connections with line-cards executing offload portions of link management;
aggregating data links into channels; and
configuring the line cards including providing aggregation information

23. The method of claim 22, comprising receiving messages from the offload portions of link management.

24. The method of claim 23, comprising updating configuration data based upon the messages.

25. An article of machine-readable media containing instructions that, when executed, cause the machine to:
receive traffic link data about aggregation of data links into channels from a control card;
exchange control link status messages with adjacent peers;
monitor synchronization of data links in a channel;
determine if there has been a control link or data link failure; and
filter and validate control packets relating to link management.

26. The article of claim 25, the instructions further causing the machine to identify link configuration changes and notify the control card.

27. The article of claim 25, the instructions causing the machine to exchange control link status further causing the machine to exchange HELLO messages in accordance with the Link Management Protocol.

28. The article of claim 25, the instructions causing the machine to monitor synchronization of data links further causing the machine to:
detect that a data link has lost synchronization; and
notify the control card of the loss.

29. The article of claim 25, the instructions causing the machine to determine if there has been a control link or data link failure further causing the machine to:
detect a loss of connectivity in a control channel;
cause an event that notifies the control card; and
set a status flag indicating that the control channel has failed.

30. The article of claim 25, the instructions causing the machine to determine if there has been a control link or data link failure, further causing the machine to:
determine that a local node is not responding to data link verification message; and
notify the control card of a data link failure.
